(19) United States
(12) Patent Application Publication
(10) Pub. No.: US 2003/0076050 A1
(43) Pub. Date: Apr. 24, 2003

(54) Propped up lamp string wound with rolled up tapes

(76) Inventor: Shun-Feng Huang, Feng-Yuan City (TW)

Correspondence Address: SHUN-FENG HUANG, P.O. Box 697, Feng-Yuan City, 420, TW

(21) Appl. No.: 09/982,394

(22) Filed: Oct. 18, 2001

(51) Int. Cl. H05B 37/00

(52) U.S. Cl. 315/185 S

(57) ABSTRACT

A propped up lamp string wound with rolled up tapes includes a string of Christmas light parallel depend on a flexible prop, a plurality of the sockets with lamp obliquely clipped on the prop at regular intervals and a rolled up tape in pencil like shaped wound on the string and the prop and heated to integrate with the string and the prop. Thereby the propped up lamp string can be bent into different shapes of pattern or gathered into a pot of a post to make a garden lamp.

### BACKGROUND OF THE INVENTION

The present invention relates to Christmas lights or garden lamp and more particularly to a propped up lamp string wound with rolled up tapes.

A string of Christmas lights is used to wind on a Christmas tree or to hang on a shaped up object in order to provide cosmetic effect. It would not make a shape itself because there is no any prop to support it. Ideally, if there is a prop made of flexible material such as the iron wire to prop it, the string of Christmas lights can be made into different shapes. However, the prop could not integrate with the lamp string if there is nothing to bind it.

### SUMMARY OF THE PRESENT INVENTION

The present invention has a main object to provide a propped up lamp string wound with rolled up tape in which the sockets of the Christmas lights are regularly depend on the prop and the electric wires of the string are parallel bound with the prop by a rolled up tape. So that it looks as integrated with each other and beatified.

Accordingly, the propped up lamp string wound with rolled up tapes of the present invention comprises generally a string of Christmas lights, a flexible prop and the rolled up tapes. The string of Christmas lights parallel depends on the prop and wound by the rolled up tapes. Then the tape is heated to be integral with the prop and the electric wires of the string of the Christmas lights. The socket of the lamps are regularly and obliquely fixed to the prop. Since the prop is flexible, the propped up lamp string can be able to make different shapes of patterns.

The present invention will become more fully understood by reference to the following detailed description thereof when read in conjunction with the attached drawings.

### BRIEF DESCRIPTION OF THE DRAWINGS

FIG. 1 is a perspective view to show the preferred embodiment of the present invention while the tape is begin to wind the prop and the electric wires,

FIG. 2 is a perspective view of FIG. 1 while the tape is already bound on the prop and the electric wires,

FIG. 3 is a front side view of the socket,

FIG. 4 is a rear side view of the socket,

FIG. 5 is a perspective view to show that the winding of the tape is finished, and

FIG. 6 is a plane view to show that the propped up string of Christmas lights can be used to a garden lamp.

### DETAILED DESCRIPTION OF THE PREFERRED EMBODIMENT

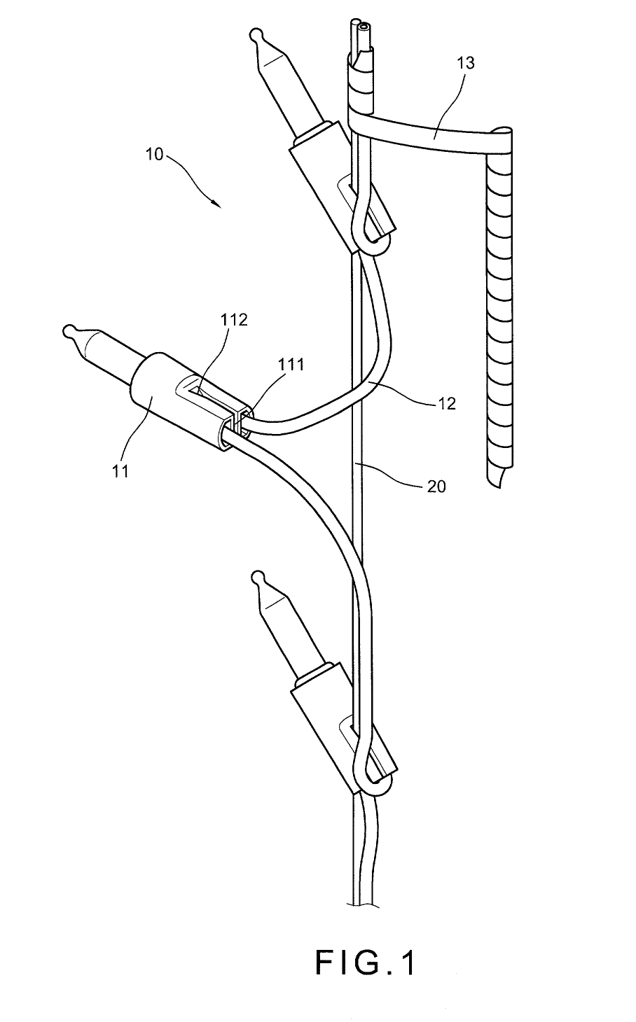

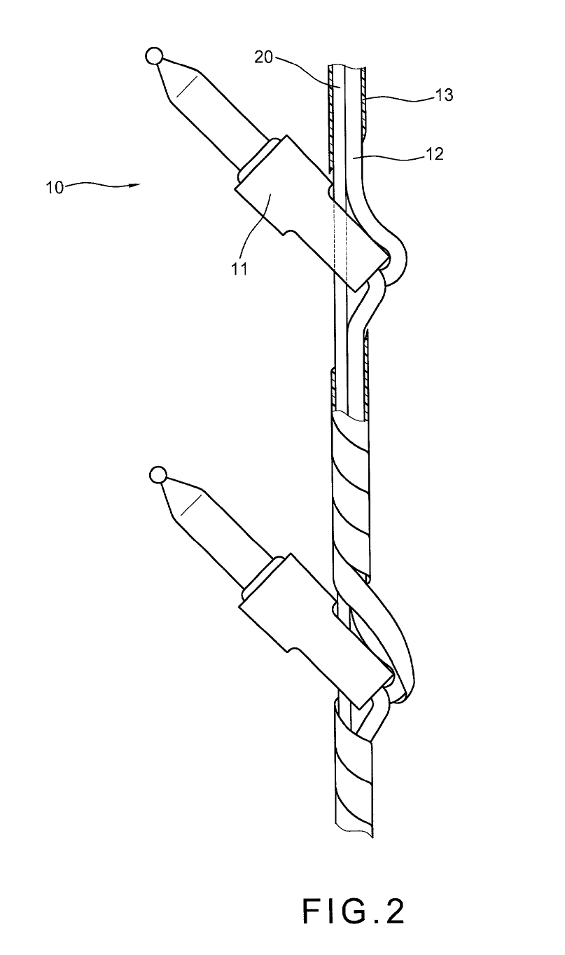

With reference to FIGS. 1 and 2 of the drawings, the propped up lamp string wound with rolled up tapes of present invention comprises generally a string of Christmas lights 10 parallel depend on a prop 20 and a rolled up tape 13 wound on the prop 20 and the electric wires 12 of the string of Christmas lights 10.

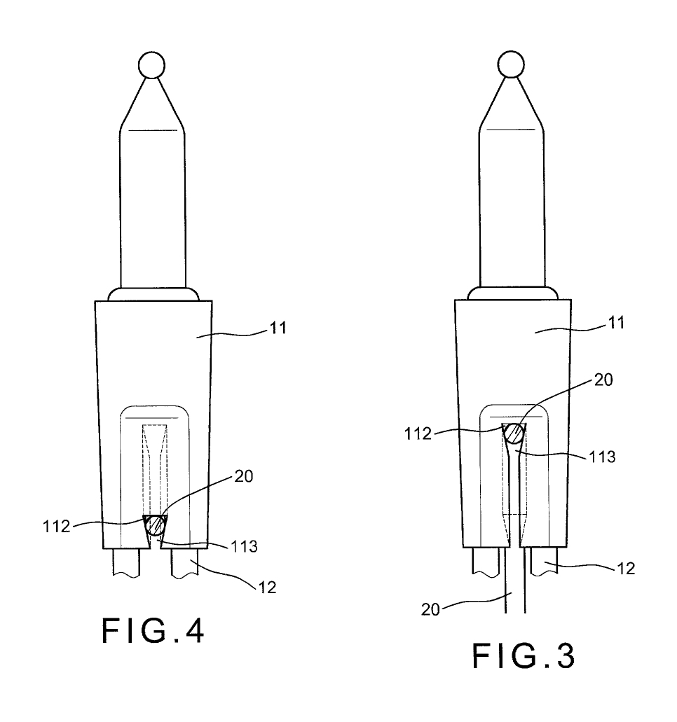

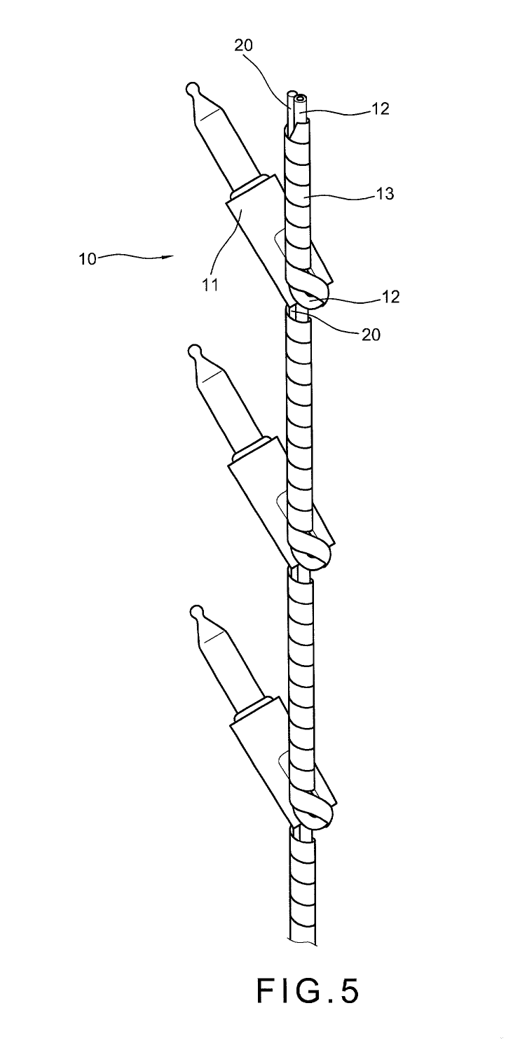

The string of Christmas lights 10 has a plurality of sockets 11 with lamps thereon. Each of the sockets 11 has a slender slit 111 in a center including an inclined bottom 112 of about 45 degrees of inclination and a narrow opening 113 (as shown in FIGS. 3 and 4) for slopedly clipping the sockets 11 on the prop 20 at regular intervals and some inclination (as shown in FIG. 5). Once the socket 11 dipped on the prop 20, it would not break a way.

The prop 20 is made of flexible material such as the pliable metal or plastic.

The rolled up tape 13 is made of plastic material and has been shaped into a pencil like shaped. So that it will be automatically and neatly wound on the prop 20 and the electric wire 12 without paying too much attentions. When meet a socket 11 on the prop 20, it will be jumped over to avoid disorder. Once the winding of the tape 13 on the prop 20 and the electric wires 12 is completed, it will be heated to integrate with the prop 20 and the electric wires 12. FIG. 5 shows an outlook of the finished product of the propped up lamp string wound with rolled up tape of the present invention which can be bent over to make different shapes of pattern.

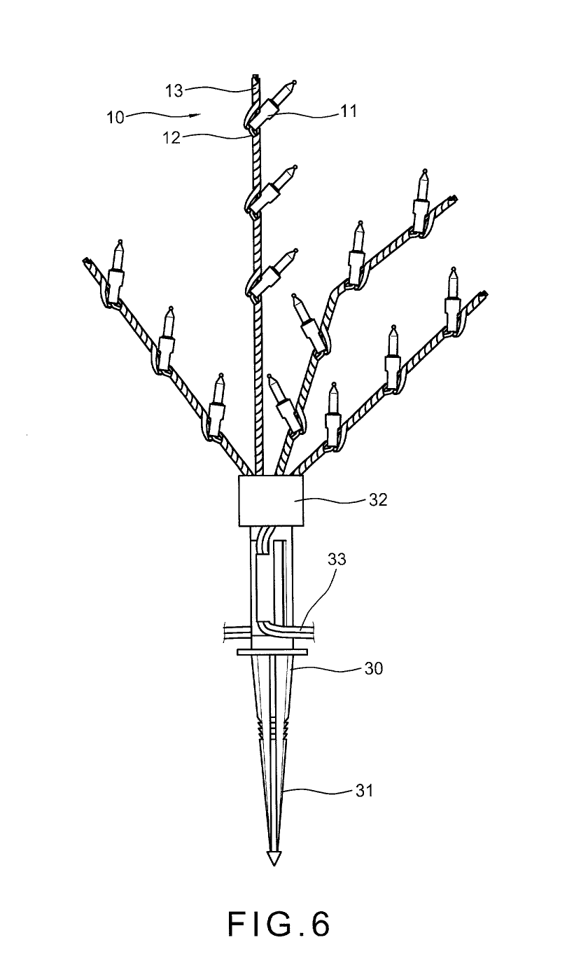

Referring to FIG. 6, this finished product can be inserted into a post 30 to make a garden lamp. The post 30 has a tip portion 31 on lower end for placing the garden lamp into a ground such as soil or lawn and pot 32 on the top to receive a plurality of the propped up lamp strings of the present invention. The electric wires 12 are gather to connected with a pair of electric wires 33 in the post 30. The electric wires 33 are capable of connecting with other garden lamps or the power source. Since the prop 20 is pliable, these propped up lamp strings can be bent over to make different shapes of flower to provide cosmetic effect.

The present invention has at least the following features:

a) the sockets of the string of Christmas lights can obliquely fixed on the prop at regular intervals,

b) the tape is shaped into a pencil like roller which is readily to bind and makes the prop and the string integral, and

c) the finished product can be bent into different shapes and can be applied to a post to make a garden lamp,

The specification relating to the above embodiment should be construed as exemplary rather than as limitative of the present invention, with many variations and modifications being readily attainable by a person of average skill in the art without departing from the spirit or scope thereof as defined by the appended claims and their legal equivalents.

I claim:

1. A propped up lamp string wound with rolled up tapes comprising:
a flexible prop;
a string of Christmas light parallel depend on the prop, said string of Christmas lights having a plurality of socket with lamp thereon obliquely clipped on the prop at regular intervals;
a rolled up tape winding on the prop and the string of Christmas lights and heated to integrate with the prop and the string of Christmas lights.

2. A propped up lamp string as recited in claim 1 wherein said prop is made of flexible material such as pliable metal and/or plastic.

3. A propped up lamp string as recited in claim 1 wherein said sockets each has a slender slit in a center including a narrow opening and an inclined bottom of about 45 degrees inclination.

4. A propped up lamp string as recited in claim 1 wherein said rolled up tape is made of plastic material and is shaped into a pencil like roller.

5. A propped up lamp string as recited in claim 1 said propped up lamp string may be gathered into a pot of a post to make a garden lamp which has a tip portion on lower portion and a pair electric wires to respectively connect with the propped up lamp strings and other garden lamps and/or power source.
